(19) United States
(12) Patent Application Publication
(10) Pub. No.: US 2018/0006489 A1
(43) Pub. Date: Jan. 4, 2018

(54) Universal Weather-Proofed Multi-Port Device Charger for Use with Various Power Sources

(71) Applicants: Joshua Chandler Pattisall, Bel Air, MD (US); Charles Adam Pattisall, Bel Air, MD (US)

(72) Inventors: Joshua Chandler Pattisall, Bel Air, MD (US); Charles Adam Pattisall, Bel Air, MD (US)

(21) Appl. No.: 15/197,242

(22) Filed: Jun. 29, 2016

(51) Int. Cl. H02J 7/14; H02J 7/00

(52) U.S. Cl. CPC H02J 7/14; H02J 7/0003; H02J 7/0045

(57) ABSTRACT

A universal charging device is disclosed. The device is configured to enable a user to charge a wide variety of mobile, battery-powered devices directly from any motor vehicle or electric vehicle battery. The device is equipped with at least one output having one or more of a variety of conventional male device charging adaptors such as micro-USB and Apple™ Lightning™ connectors. A modular input equipped with alligator clips is configured to connect to the battery terminals of the automotive battery. A small, water proof and impact-resistant body houses electric components providing for the automatic conversion of DC power of varying voltages and amperage discharge rates to the requisite low amp, low voltage supply of power to the at least one output to charge at least one mobile device safely with ease.

### FIELD OF THE PRESENT INVENTION

The present invention relates to battery-powered devices, and more specifically relates to a universal device charger configured to charge wireless devices from a variety of power sources with different ampere discharge rates and voltages.

### BACKGROUND OF THE PRESENT INVENTION

Conventionally, battery powered devices such as mobile phones, mobile computer, tablets, iPod™ devices, personal digital assistants, satellite phones, smartwatches, personal vaporizers, digital audio players, portable gaming devices, and other portable electronics are equipped with rechargeable battery cells that may be recharged numerous times. Many modern devices are configured to be charged with common, industry standard connectors (USB varieties including USB-A, USB-B, micro-USB, mini-USB, etc.) that employ standardized output amperage ranges, often 0.5 volts at 1.0 Amps. This power range is obtained via mass-produced AC/DC adaptors (for use with AC power) and DC/DC plug adaptors (for use with a conventional female cylindrical DC power supply), which is then supplied to a female USB connector for use in charging the mobile device.

Unfortunately, conventional cylindrical DC power supply is not available on many vehicles, especially smaller vehicles such as motorcycles, ATVs, golf carts, snowmobiles, boats, dune buggies, or other devices or transports powered by automotive batteries. As such, mobile device users are left without a DC power supply port in which to plug their DC/DC adaptors for charging their devices while on these vehicles. This can be disastrous in remote locations, such as while boating, or motorcycling in the desert, as without a charged mobile phone, users are less likely to locate and acquire assistance rapidly.

Some industrious individuals have fashioned makeshift adaptors for use with the battery of a single vehicle, employing electronic components that enable the step-down of voltage required to charge a device; however, the makeshift adaptor is fashioned for use on a single vehicle, and cannot therefore be used with another vehicle with different battery specifications (such as attempting to use the makeshift device designed for a boat battery with an ATV battery instead). Additionally, such a device is often not easily transported or uninstalled, and is not easy to use by those not educated in the basics of electrical engineering.

Thus, there is a need for a new universal charging adaptive apparatus configured to interpret the input power supply from a battery, and adjust charging output voltage and amperage at the will of the user for the specifications of the target device to be charged, enabling mobile device owners to charge their devices from the battery of any vehicle battery. Such a device preferably attaches directly to any automotive battery easily via clamps or alligator clips, and rapidly charges multiple devices simultaneously via a DC-DC power converter. Multiple outputs are employed to convey the power to the mobile devices via conventional USB-based connectors.

### SUMMARY OF THE PRESENT INVENTION

The present invention is an apparatus configured to charge one or more mobile devices via an external automotive battery, small engine battery (motorcycle, ATV, Golf Cart, etc.) electric-power cell, or marine battery. The preferred embodiment of the present invention is equipped with at least one output, a modular input, at least one cable, and a body. The at least one output is preferably equipped with at least one male connector, which is preferably at least one conventional male USB connector, such as a USB-micro or Apple™ Lightning™ USB connector, in communication with the body via the at least one cable. The modular input is preferably equipped with a clamp connector, alligator clip connector, or other adjustable connector configured to attach to a wide range of battery terminals, preferably including battery terminals up to one inch in diameter, and is also in communication with the body via at least one cable.

The body houses electric components including a DC-DC converter, providing for the present invention to convert 5-60V DC power from an automotive or small engine battery to the 1-5V, 1 amp DC power (3 A max) required by most portable devices. It is envisioned that the body of the present invention may vary in size, but is preferably small, and may be fashioned as an in-line module between the at least one output and the modular input. Additionally, the body is preferably water-resistant and impact resistant.

### BRIEF DESCRIPTION OF THE DRAWINGS

The present invention will be better understood with reference to the appended drawing sheets, wherein:

FIG. 1 displays an environmental view of the primary embodiment of the present invention, showing the front and the side of the present invention.

FIG. 2 exhibits a flow chart detailing the preferred process of use of the present invention.

### DETAILED DESCRIPTION OF THE PREFERRED EMBODIMENT

The present invention generally comprises a charging device equipped with at least one output (10), a modular input (20), and a body (30). The at least one output (10) is preferably equipped with a conventional male USB connector (40), including, but not limited to, USB-A Micro, USB-B Mini, USB, USB 3.0 micro, USB-C, USB nano, Apple™ Lightning™ connector, Apple™ 30 pin dock connectors, and other universal male serial bus connectors conventionally used for charging portable electronics. The modular input (20) is configured to affix to an automotive or similar conventional (commonly 5-12V, but may be other) battery via alligator clips (60) or other similar instant, electrically conductive clamp mechanism, and at least one cable (80).

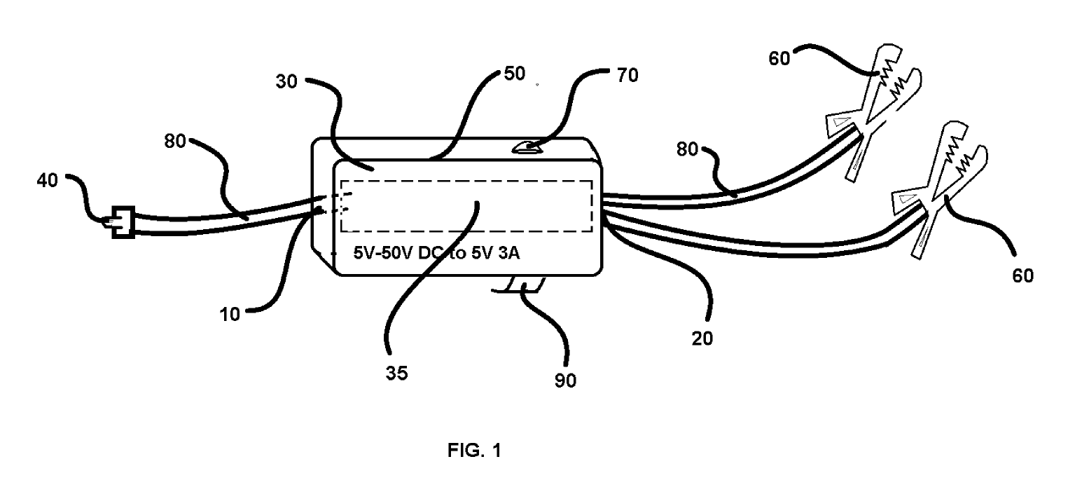

As the personal mobile devices to be charged via the present invention are powered by DC power, and the modular input (20) is configured to only accept power from a DC power source, minimal components are required within the body (30) to achieve the function of the present invention. A DC-DC converter (35) is disposed within the body (30) and is in communication with the at least one output (10) and the modular input (20) of the present invention. It should be understood that the body (30) of the present invention is disposed in-line, and preferably has a compact form-factor as seen in FIG. 1.

The body (30) of the present invention is a casing preferably equipped with waterproofed seams (50) employing at least one rubber O-ring seal or equivalent to help ensure that water, dust, and other debris do not enter the body (30). Additionally, the body (30) is preferably fashioned of impact resistant plastic, polymer, or acrylic, and is preferably stress tested to withstand the force of being dropped from a height of five feet onto a hard surface. The body (30) of the present invention may also be equipped with a cable mount (90) or similar designated location for the placement of the at least one cable (80) of the present invention when not in use, providing for the at least one cable (90) to be wound around the body (30) temporarily, and held in position via the cable mount (90) for storage.

In the preferred embodiment of the present invention, the body (30) is equipped with at least one LED indicator light (70), powered via the automotive battery in communication with the modular input (20) via the alligator clips (60). It is envisioned that battery terminal clamps or similarly conductive clamps may be used in lieu of alligator clips (60). The at least one LED indicator light (70) is configured to illuminate green when the present invention is connected and charging at least one device, and will preferably illuminate red if a poor connection is used, the battery is depleted, or a device is not connected to the at least one output (10) of the present invention.

It is envisioned that alternate embodiments of the present invention may provide a means to connect other DC powered devices which are configured to be charged via a conventional ‘barrel connector’ or other similar cylindrical connector. Additionally, other embodiments of the present invention may be equipped with an internal battery. In such embodiments, when the present invention is affixed to a power source via the modular input (20), the present invention will power both the device(s) in communication with the device via the at least one output (10), as well as the internal battery. As such, the internal battery provides for the present invention to continue to charge a portable device after the modular input (20) has been disconnected from the power source.

Additionally, it is envisioned that, in alternate embodiments of the present invention, the at least one output (20) of the present invention is equipped with at least one female USB, providing for the user of the present invention to employ his or her own USB-based charging cable with the present invention to charge his or her portable device. In such an embodiment, the at least one output (20) of the present invention may be at least one physical female USB port disposed along the outer perimeter of the body (30), and is preferably equipped with rubber or silicone male inserts to help maintain the weather-proof rating of the body (30) of the present invention when not in use.

Alternate embodiments of the present invention may also be equipped with a reverse polarity protector and/or polarity alarm that will alert the user in the event that the alligator clips (60) are disposed on incorrect battery terminals. The alert is preferably supplied visibly, via an alternate color displayed via the at least one LED indicator light (70), such as orange or violet. Some embodiments of the present invention may employ a small speaker housed within the body (30) to provide an audible alert to the user in the event that the polarity is incorrect. In the event that the polarity is connected incorrectly, the polarity protector of the present invention will detect the mistake, and prevent operation of the present invention until the polarity is reversed.

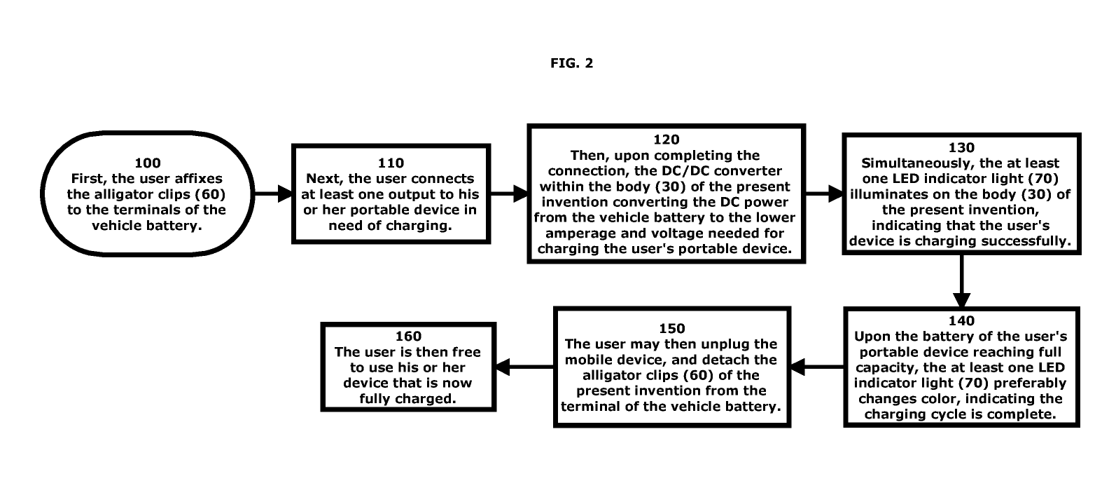

The method of use of the present invention, as seen in FIG. 2, is preferably as follows:

First, the user affixes the alligator clips (60) to the terminals of the vehicle battery. (100). Next, the user connects the at least one output to his or her portable device in need of charging. (110). Then, upon completing the connection, the DC/DC converter within the body (30) of the present invention converting the DC power from the vehicle battery to the lower amperage and voltage needed for charging the user's portable device. (120) Simultaneously, the at least one LED indicator light (70) illuminates on the body (30) of the present invention, indicating that the user's device is charging successfully. (130) Upon the battery of the user's portable device reaching full capacity, the at least one LED indicator light (70) preferably changes color, indicating the charging cycle is complete. (140) The user may then unplug the mobile device, and detach the alligator clips (60) of the present invention from the terminal of the vehicle battery. (150) The user is then free to use his or her device that is now fully charged. (160)

It should be understood that the alligator clip (60) connector, or other adjustable connector is configured to attach to a wide range of battery terminals, preferably including battery terminals up to one inch in diameter.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A modular charging device for portable electronic devices comprising:
at least one output;
a modular input;
a body; and
a D/C to D/C converter housed within said body.

2. The modular charging device of claim 1, wherein said modular input is equipped with alligator clips; and
wherein said alligator clips are configured to convey power from a vehicle battery to said modular input.

3. The modular charging device of claim 2, wherein said at least one output is equipped with at least one male charging connector.

4. The modular charging device of claim 3, wherein said at least one male charging connector is at least one of the following ports: USB-A Micro, USB-B Mini, USB, USB 3.0 micro, USB-C, USB nano, Apple™ Lightning™ connector, and Apple™ 30 pin dock connectors.

5. The modular charging device of claim 1, wherein said body is disposed in-line at least one cable configured to convey power from said modular input to said at least one output.

6. A method of charging a portable device via a vehicle battery comprising:
affixing at least one alligator clip to the terminals of the vehicle battery;
connecting at least one output to the portable device;
a DC/DC converter converting the 12V from the vehicle battery to 5V, 3 A maximum, and supplying the converted power to the at least one output; and
the battery of the portable device charging until capacity is reached.

7. The method of claim 6, wherein said at least one output is a female USB port; and
Wherein the female USB port is configured to receive a male USB connector from a cable having a portable device charging connector;

8. The method of claim 7, wherein the portable device charging connector is one of the following: USB-A Micro, USB-B Mini, USB, USB 3.0 micro, USB-C, USB nano, Apple™ Lightning™ connector, and Apple™ 30 pin dock connectors.
